(19) United States
(12) Patent Application Publication
(10) Pub. No.: US 2009/0015847 A1
(43) Pub. Date: Jan. 15, 2009

(54) PRINTER-INITIATED PRINTING METHOD AND APPARATUS

(75) Inventor: Qi Luo, San Mateo, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 11/776,541

(22) Filed: Jul. 11, 2007

(51) Int. Cl. G06F 3/12

(52) U.S. Cl. 358/1.1

(57) ABSTRACT

A printing method that allows a user to initiate printing of files on a host computer from the printer side with one or more button touches. The user initiates printing from the printer using one or more buttons, such as a dedicated easy print button. The printer sends a data request to the host computer. A printer monitoring program on the host computer receives and responds to printer requests. Upon receiving the data request from the printer, the host computer finds the most active application window (the window on top of all other windows), calls the application's default printing setting, generates a printing task for the most active opened file, and sends it to the printer. The printer prints the file received from the host computer. Other printing modes are also possible, such as printing all opened files in the most active application, etc.

### BACKGROUND OF THE INVENTION

1. Field of the Invention

This invention relates to a printer, and in particular, it relates to a printer having a physical or virtual control button for initiating printing of a document on a host computer and related method and apparatus.

2. Description of Related Art

Conventionally, when a user desires to print a file from his computer, he initiates printing from his computer, typically by invoking a print command from the relevant application program and going through the print control user interface (dialog box). The user typically need to use multiple mouse clicks or key strokes to accomplish the printing, even if the user only needs to print the document with default printing settings. The user then needs to go to the printer to pick up the printed document.

In addition, the user may need to check if desired recording sheets for a particular print are loaded in the printer or not before instructing his computer to send a print command to the printer. In such a case, he needs to go to the printer to load such the recording sheets, to go back to his computer to initiate the print, and to go again to the printer to pick up the printed document.

### SUMMARY

The present invention is directed to a printing method and apparatus that substantially obviate one or more of the problems due to limitations and disadvantages of the related art.

An object of the present invention is to provide a method and apparatus for easy printing. The method allows a user to print files on a host computer from the printer side with one or more button touches.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a printing method in a data processing system including a host computer and a printer connected to each other, the printer including a control panel for inputting commands, the method including: (a) inputting a print command from the control panel of the printer; (b) in response to the print command, the printer transmitting a data request to the host computer; (c) in response to the data request, the host computer finding one or more active opened files on the host computer; (d) the host computer transmitting a print job to the printer for printing the one or more active opened files using a default printing settings; and (e) the printer printing the one or more files received from the host computer. The print command may identify one of a plurality of printing modes.

In another aspect, the present invention provides a printer adapted to be connected to a host computer, the printer including: a printing section; a control panel for inputting commands including a print command; and a control section controlling the functions of the printer, wherein in response to the print command inputted via the control panel, the control section transmits a data request to the host computer to request one or more active opened files on the host computer, and wherein the printer receives files from the host computer and prints them. The control panel may include one or more dedicated buttons for inputting the print command, and may further include a display screen for displaying a preview of the host computer's desktop.

In yet another aspect, the present invention provides a computer usable medium having a computer readable program code embedded therein for controlling a host computer, the host computer adapted to be connected to a printer, the computer readable program code configured to cause the host computer to execute a process, the process including: (a) monitoring data requests received from the printer; (b) in response to a received data request, finding one or more active opened files on the host computer; and (c) transmitting a print job to the printer for printing the one or more active opened files using a default printing settings.

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates a printer and host computer system in which embodiments of the present invention may be implemented.

FIG. 2 illustrates a control panel of a printer according to an embodiment of the present invention.

FIG. 3 is a flow chart illustrating a printing method according to an embodiment of the present invention.

### DETAILED DESCRIPTION OF PREFERRED EMBODIMENTS

Printing methods according to embodiments of the present invention allow a user to initiate printing of files on a host computer from the printer side with one or more button touches. The user initiates printing from the printer using one or more buttons on a control panel. The printer sends a data request to the host computer to request data. A printer monitoring program is installed on the host computer, which receives and responds to printer requests. Upon receiving the data request from the printer, the host computer finds the most active application window (the window on top of all other windows), calls the application's default printing setting, generates a printing task for the most active opened file, and sends it to the printer. Other printing modes are also possible, as described in more detail below.

FIG. 1 illustrates a system implementing a printing method according to embodiments of the present invention. As shown in FIG. 1, a printer 20 and a host computer 10 are connected by a communication link 30, which may be a communication cable or a network (wired or wireless). The printer 20 includes a control section 21, a control panel 22, a printing section 23 for generating images on a medium (recording sheet), and other necessary or optional components (not shown). The control panel 22 includes one or more buttons or other input devices that allow a user to input a print command to initiate printing of files on the host computer from the printer. The control section 21 controls various functions of the printer, including interpreting the commands inputted from the controller panel 22. When a print command is inputted from the control panel 22, the control section 21 generates and transmits a data request to the host computer 10.

The control panel 22 may have any suitable design. In one embodiment, one or more dedicated “easy print” buttons are provided on the control panel 22 to input print commands to initiate printing. In another embodiment, the control panel 22 includes one or more buttons and a display screen, and a menu system is implemented to allow the user to input commands to initiate printing. In another embodiment, a touch screen is used for inputting commands. The user may also input multiple print commands for different printing modes, such as: printing the most active opened file in the most active application on the host computer, printing all opened files in the most active application, printing the most active opened file in all active applications, printing all opened files in all active applications, etc. In one embodiment, one dedicated button is used to input print commands for different printing modes by generating different signal patterns. For example, one short (quick) press of the button, two successive short presses, one long press (e.g. press and hold for 2 seconds), and one short followed by one long press may represent print commands for the above four printing modes, respectively. In another embodiment, a plurality of dedicated buttons are provided, each representing one or more of the above print commands.

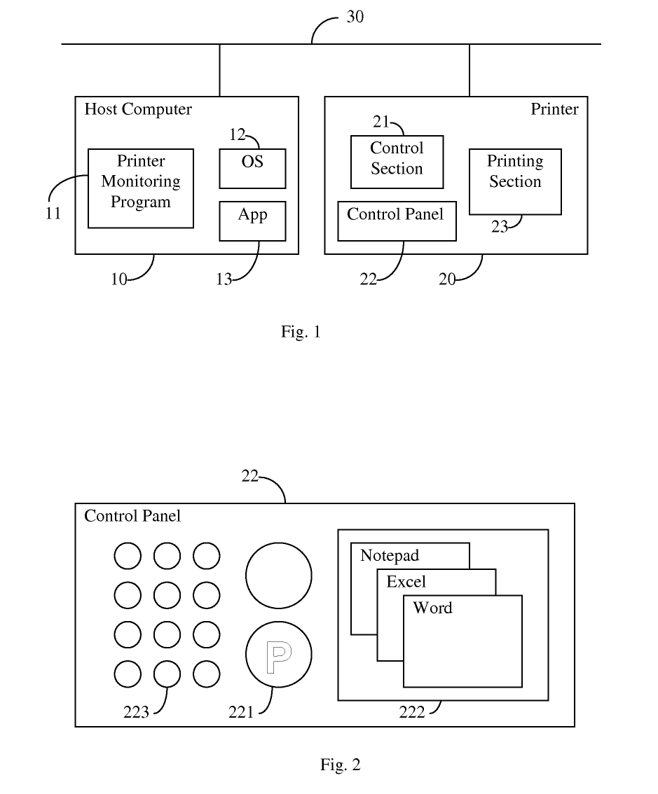

Optionally, to provide more convenience for the user, a display screen may be provided on the control panel to display a preview of the document to be printed. The preview display may display the host computer's desktop in real-time to ensure that the right file is being chosen for printing. The user may request the desktop preview using the control panel. For example, the dedicated button may be programmed so that the first press of the button causes a desktop preview to be displayed on the screen, and a second press within a defined time period initiates the printing. FIG. 2 schematically illustrates a control panel 22 of the printer 20. The control panel has a desiccated easy print button 221, a display screen 222 showing the image of the desktop of the host computer, and other buttons 223. In the illustrated example, the display screen shows that three windows (application programs) are open on the host computer, and that Word is the most active application. The control panel 22 shown in FIG. 2 is exemplary only and any other suitable designs may be employed. For example, the dedicated print button may be physically provided at a location separate from the other buttons.

In the system shown in FIG. 1, if the printer 20 is a network printer and multiple computers are connected to the network, one computer on the network may be set as the printer's host computer which responds to the printer initiated print requests. The network address of the host computer may be stored in the printer as its host's network address. For network security reasons, usernames and passwords may be stored in the printer to be used to access its network host computer. Preferably, the stored host network address can be changed at anytime so users can access files on different network computers.

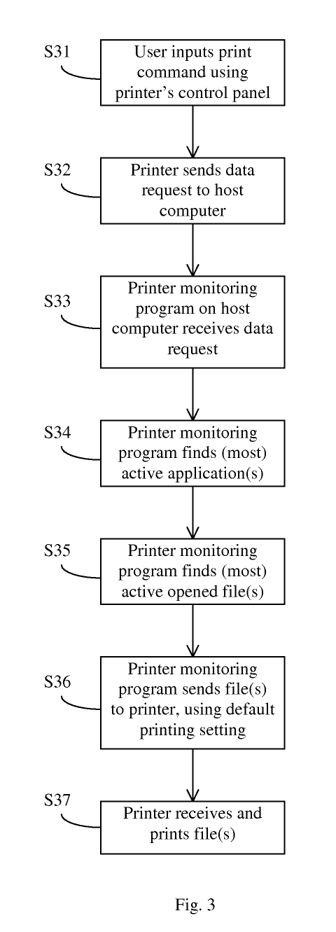

As shown in FIG. 1, the host computer 10 includes a printer monitoring program 11 that monitors data requests received from the printer 20 and responds to the requests. The host computer 10 also has an operation system program 12 and zero or more application programs 13 running on it. Other necessary or optional components of the host computer are not shown. The printer monitoring program 11 is a program that runs in the background (and may run on the task bar in a Windows environment), and its functions are described with reference to FIG. 3.

As shown in FIG. 3, once the user inputs a print command using the printer's control panel (step S31), the printer sends a data request to the host computer to request data (step S32). When the printer monitoring program 11 on the host computer 10 receives the data request from the printer 20 (step S33), it finds the most active application program running on the host computer (step S34). In the Windows environment, the most active application is typically the application whose window is on top of other application program windows. The FindWindow( ) function may be used to retrieve a handle to the top-level window whose class name and window name match the specified parameters. The printer monitoring program 11 also finds the most active application's most active opened file (step S35). In Windows, this may be done by getting the opened file information list from the windows registry. For example, to find the most active opened file from Word, the registry operating APIs may be used to retrieve the value(s) of the key HKEY_CURRENT_USER\Software\Microsoft\Office[version number]\Word\File MRU. The printer monitoring program 11 sends the file thus found to the printer, using the application's default printing setting for the print job (step S36). Although steps S35 and S36 are illustrated as separate steps, they may be performed in one step, in which the printer monitoring program 11 causes the applications' printing function to be executed in the background which sends the application's most active opened file to the printer. There are many ways to accomplish this; one simple way is to provide a script to execute the applications' printing function in the background. The script automatically sends the application's most active opened file to be printed using the default setting. The printer 20 receives the print job and prints it (step S37).

If a desktop preview is to be displayed on the screen of the control panel, the printer sends a preview request to the host computer in response to a user command, and the host computer responds by transmitting data representing the desktop image at that time. These steps are performed before step S31 (not shown in FIG. 3).

As mentioned earlier, in alternative embodiments the user may input print commands for different printing modes. Depending on the printing mode, steps S34 and S35 may include finding other active applications in addition to the most active application and finding other active opened files in addition to the most active opened file. In step S36, all files found in steps S34 and S35 are sent to the printer to be printed.

In step 36, using the default printing setting means that no user interaction is required to set the printing setting at this stage. The default printing setting may be any setting previously set by the user (and can be changed by the user) or a default factory setting.

The various steps shown in FIG. 3 and described above may be implemented by software, firmware or hardware on the printer and the host computer, respectively.

Although the term “printer” is used in the above description, the printer 20 may be a device that combines printer, copier and or scanner functions, sometimes referred to as a multi-function apparatus (MFP) or an all-in-one (AIO) device.

The printer-initiated printing method and apparatus according to embodiments of the present invention has several advantages. It provides a convenient way of initiating printing by simple button operation on the printer. It minimizes the printing task sending time to the user. It can also eliminate a common mistake of sending print jobs to wrong printers, as printing jobs will be sent to the printer that the user is operating at.

Although initiating printing from the printer brings many advantages, parts of the method described above and shown in FIG. 3 may be practiced on the host computer alone. Specifically, a print program may be implemented on the host computer to perform steps S34 (the program finds the most active application), S35 (the program finds the most active opened file of the application) and S36 (the program sends the file thus found to the printer using default printing setting) when activated by the user. For example, an icon (akin to a virtual “easy print” button) may be put on the task bar of the host computer's desktop, so that when the user clicks the icon, a print job for the most active opened file of the most active application will be generated and sent to the default printer. Such an implementation has the advantage that it does not require any modification on the printer's side, but the downside is that user will lose the convenience of initiating the print job from the printer side.

It will be apparent to those skilled in the art that various modification and variations can be made in the printer-initiated printing method and related apparatus of the present invention without departing from the spirit or scope of the invention. Thus, it is intended that the present invention cover modifications and variations that come within the scope of the appended claims and their equivalents.

What is claimed is:

1. A printing method in a data processing system including a host computer and a printer connected to each other, the printer including a control panel for inputting commands, the method comprising:
(a) inputting a print command from the control panel of the printer;
(b) in response to the print command, the printer transmitting a data request to the host computer;
(c) in response to the data request, the host computer finding one or more active opened files on the host computer;
(d) the host computer transmitting a print job to the printer for printing the one or more active opened files using a default printing settings; and
(e) the printer carries out a print operation in accordance with the print job received from the host computer.

2. The method of claim 1, wherein step (c) includes finding a most active application and a most active opened file for the most active application.

3. The method of claim 1, wherein in step (a), the print command identifies one of a plurality of printing modes, the plurality of printing modes including: printing a most active opened file in a most active application on the host computer, printing all opened files in the most active application on the host computer, printing a most active opened file in each active applications on the host computer, and printing all opened files in all active applications on the host computer.

4. The method of claim 3, wherein in step (c), the host computer finds the one or more active opened files in accordance with the printing mode.

5. The method of claim 3, wherein the control panel on the printer includes a dedicated button for inputting the print command, the dedicated button capable of generating a plurality of signal patterns representing the plurality of printing modes.

6. The method of claim 3, wherein the control panel on the printer includes a plurality of dedicated buttons for inputting print commands representing the plurality of printing modes.

7. The method of claim 1, wherein the control panel on the printer includes one or more dedicated buttons for inputting the print command.

8. The method of claim 1, the control panel of the printer further including a display screen, the method further including:
(f) prior to step (a), the printer displaying a preview of a desktop image of the host computer on the display screen.

9. The method of claim 8, further comprising:
(g) prior to step (f), inputting a command requesting a preview to be displayed; and
(h) in response to the command in step (g), the printer transmitting a preview request to the host computer; and
(i) in response to the preview request, the host computer transmits data representing the desktop of the host computer.

10. The method of claim 1, wherein the printer and the host computer are connected by a network, the method further comprising storing a network address of the host computer on the printer.

11. The method of claim 10, further comprising changing the stored network address of the host computer.

12. A printer adapted to be connected to a host computer, the printer comprising:
a printing section;
a control panel for inputting commands including a print command, the print command identifying one of a plurality of printing modes, the plurality of printing modes including: printing a most active opened file in a most active application on the host computer, printing all opened files in the most active application on the host computer, printing a most active opened file in each active applications on the host computer, and printing all opened files in all active applications on the host computer; and
a control section controlling the functions of the printer, wherein in response to the print command inputted via the control panel, the control section transmits a data request to the host computer to request one or more active opened files on the host computer in accordance with the printing mode identified by the print command, and
wherein the printer receives a print job containing the one or more active opened files from the host computer and carries out a print operation in accordance with the print job.

13. The printer of claim 12, wherein the control panel includes one or more dedicated buttons for inputting the print command.

14. The printer of claim 12, wherein the control panel includes a dedicated button for inputting the print command, the dedicated button capable of generating a plurality of signal patterns representing the plurality of printing modes.

15. The printer of claim 12, wherein the control panel includes a plurality of dedicated buttons for inputting print commands representing the plurality of printing modes.

16. The printer of claim 12, wherein the control panel further includes a display screen, and
wherein the control section transmits a preview request to the host computer, receives data representing a desktop image of the host computer, and displays the desktop image on the display screen as a preview.

17. A computer program product comprising a computer usable medium having a computer readable program code embedded therein for controlling a host computer, the host computer adapted to be connected to a printer, the computer readable program code configured to cause the host computer to execute a process, the process comprising:
(a) monitoring data requests received from the printer;
(b) in response to a received data request, finding one or more active opened files on the host computer; and
(c) transmitting a print job to the printer for printing the one or more active opened files using a default printing settings.

18. The computer program product of claim 17, wherein step (b) includes finding a most active application and a most active opened file for the most active application.

19. The computer program product of claim 17, wherein the data request identifies one of a plurality of printing modes, the plurality of printing modes including: printing a most active opened file in a most active application on the host computer, printing all opened files in the most active application on the host computer, printing a most active opened file in each active applications on the host computer, and printing all opened files in all active applications on the host computer, and
wherein step (b) includes finding the one or more active opened files in accordance with the printing mode.
